(19) United States
(12) Patent Application Publication
(10) Pub. No.: US 2002/0192585 A1
(43) Pub. Date: Dec. 19, 2002

(54) Electrophotographic dry toner comprising angle-dependent luster pigments

(75) Inventors: Gunter Brenner, Griesheim (DE); Hans-Dieter Bruckner, Darmstadt (DE); Wolfgang Hechler, Lautertal (DE); Burkhard Krietsch, Dieburg (DE); Matthias Kuntz, Seeheim-Jugenheim (DE); Michael Schmelz, Griesheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/147,922

(22) Filed: May 20, 2002

(30) Foreign Application Priority Data
May 18, 2001 (DE) 101 24 657.9

(51) Int. Cl. G03G 9/09

(52) U.S. Cl. 430/108.6; 430/108.7; 430/108.1; 430/111.4; 430/120

(57) ABSTRACT

The invention relates to a dry toner for laser printing which comprises at least one viewing angle-dependent (“angle-dependent”), platelet-shaped luster pigment. The luster pigment consists of a multicoated, platelet-shaped, opaque or semi-transparent substrate. The toner is particularly suitable for security printing. The invention furthermore relates to a process for the production of images by electrophotographic methods using the dry toner.

The present application relates to an electrophotographic dry toner for laser printing. It furthermore relates to a process for the production of images by electrophotographic methods using the dry toner.

Dry toners for the development of electrostatic charge images, as are formed in photocopiers and laser printers, are known and described in large number (for example by H. T. Macholtin in “Organische Pigmente für Photokopierer und Laserdrucker” [Organic Pigments for Photocopiers and Laser Printers] in Chemie in unserer Zeit, 24 [1990] 176-181). They generally comprise binders, pigments, charge directors, optionally also charge adjuvants. The charge directors cause the effect that the toner can be positively or negatively charged and adheres to the carrier particles, which are significantly larger than the toner particles. In general, the diameter of the carrier particles is from 50 to 100 μm. By comparison, the particle size of the toner particles is generally in the range from 2 to 15 μm, and the mean particle size is approximately from 5 to 10 μm. The carrier frequently consists of iron oxide/magnetite or surface-oxidized iron powder, but can also be produced from sodium chloride, sodium nitrate, aluminium nitrate, ammonium chloride, polymethyl methacrylate:silicon dioxide, glass, steel or nickel. The type of carrier depends, inter alia, on the polarity of the toner. In a positively-chargeable toner, the carrier must adopt negative polarity so that the toner adheres to the carrier. The weight ratio of toner to carrier is generally from 1:10 to 1:200. During mixing with the carrier, the toner particles are triboelectrically charged. However, the carrier is only an assistant by means of which the toner is transferred in the photocopier or laser printer.

The core element in laser printers and photocopiers is the so-called photoconductor. This is generally a roller or drum made from an electrically conductive material which carries a thin photoconductive layer. The photo-conductor is electrostatically charged in the dark and subsequently exposed imagewise. The light source used in laser printers is an electronically modulated laser beam. The electric charge is dissipated from the surface of the photoconductor only in the exposed areas, resulting in the formation of a latent electrostatic charge image. This is then rendered visible by means of correspondingly charged toner particles. Laser printers generally work by the reversal process. Photoconductors and toner particles then have the same charge (in photocopiers, by contrast, the photoconductor and toner particles usually have opposite electrostatic charges). A specifically applied voltage causes the toner particles to jump over onto the areas of the photoconductor charged by the action of the laser beam. In the process, the toner particles detach from the carrier particles. The carrier itself remains on the magnetic roller. In a further step, the toner is then transferred from the photoconductor to the paper or another receiving material (for example a plastic film) by application of a countervoltage. The toner image is fixed by fusing to itself and to the receiving material. In the meantime, color copiers or color laser printers also enable the production of multicolored copies or prints which are in some cases of such high quality that they are virtually indistinguishable from the originals. In this way, it is also possible to reproduce and accordingly also to counterfeit originals which were hitherto substantially counterfeiting-proof (banknotes, colored certificates of all types).

In security printing, particular efforts have therefore been made to improve counterfeiting security. One way of achieving this security is the use of OVDs (optical variable devices). These are printed-on or stuck-on security features whose optical or color impression changes with the viewing angle of the observer. A known example thereof are the holograms frequently used in the production of banknotes or credit cards. In addition, the use of colored pigments whose color impression changes correspondingly is also known. The cause of this change is a color interference effect, in which the light is refracted and reflected at a plurality of very thin optically active layers on a platelet-shaped support material. The layer thickness here must be kept precisely constant, which makes high technical demands. The effect can only be copied with extreme difficulty and cannot be reproduced using color copiers. Pigments having a varying hue of this type (also known as “angle-dependent luster pigments”) are used, for example, in more recent US banknotes. These banknotes are produced by steel gravure printing using solvent-containing printing inks in paste form. A design change is always time-consuming and expensive. This technique is therefore not suitable for small runs.

An object was therefore to make the said special pigments available for security printing with small runs.

This object has been achieved by means of a dry toner which comprises angle-dependent, platelet-shaped pigments and can readily be used in laser printers.

The present invention accordingly relates to an electrophotographic dry toner for laser printing which comprises at least one angle-dependent, platelet-shaped luster pigment. The angle-dependent, platelet-shaped luster pigment is preferably a pearlescent pigment.

The proportion of angle-dependent pigment is selected here depending on the requirements. It is advantageously from 10 to 99% by weight, preferably from 20 to 95% by weight, in each case based on the total weight of the toner. In each case, the proportion of angle-dependent pigments may only be so high that the toner image can still be reliably fixed. The proportion is thus also dependent on the type and amount of the binder and the other toner constituents.

The angle-dependent pigments may be the only colored pigments in an otherwise colorless toner. However, in addition to the angle-dependent luster pigments, the toner preferably also comprises further pigments with no interference effect. These may be black pigments (in particular carbon-black pigments) or colored pigments. These further pigments provide a—preferably black or dark—background for the viewing angle-dependent luster effect. The combination of colored pigments with no interference effect with angle-dependent luster pigments enables particularly attractive color effects to be achieved. A toner according to the invention can be produced, for example, by mixing a known, in particular black, toner with a corresponding amount of viewing angle-dependent pearlescent pigments. Toners of this type are commercially available, for example for use in office laser printers.

Angle-dependent luster and pearlescent pigments and processes for their production are known and are described, for example, in DE-A 196 18 568 and 198 17 286, EP-A 0 753 545, 0 768 343, 0 823 928, 0 892 832 and 0 940 451, and WO 96/34917 and 97/39066. They generally contain platelet-shaped substrates which are coated with a plurality of very thin layers. Preference is given to substrates made of mica, glass, graphite, graphite-coated mica or aluminium oxide, in addition also iron oxide flakes, TiO₂ flakes or SiO₂ flakes. The substrate here may be transparent, semi-transparent or opaque. The thickness of the platelet-shaped substrates is generally from 10 to 1000 nm, preferably from 40 to 500 nm. By contrast, the length and width of the substrates are significantly greater. They are generally from 2 to 200 μm, preferably from 5 to 50 μm. The layers applied to the substrate are homogeneous per se and in addition have a very uniform thickness, which is preferably from about 2 to 800 nm, particularly preferably from about 5 to 600 nm. Their thickness is also determined by the refractive index of the layer material. It is particularly favorable for layers of high refractive index and those of lower refractive index to follow one another. The difference between the refractive indices is then generally at least 0.1, preferably at least 0.2. The layers of high refractive index preferably consist of a metal or metal oxide, such as nickel, aluminium, TiO₂, ZrO₂, Fe₂O₃, Fe₃O₄, Cr₂O₃ and/or ZnO. The layers of lower refractive index preferably consist of Al₂O₃ and/or SiO₂/MgF₂. The thickness of the layers of the metal oxide of high refractive index is generally from 10 to 300 nm, preferably from 20 to 200 nm, and the thickness of the metal layers is from about 5 to 35 nm. The thickness of the layers consisting of the metal oxide of lower refractive index is generally from 2 to 800 nm, preferably from 200 to 600 nm. A pronounced color flop is then observed. A platelet-shaped substrate surrounded by a first layer of a metal oxide of high refractive index or of a metal, a second layer of a metal oxide of low refractive index and a third layer of a metal oxide or of a metal, where the difference between the refractive indices of the said layers is at least 0.1, is particularly suitable.

The pearlescent effect arises if the substrate carries a plurality of layers of a material of high refractive index and the thickness of the individual layers is less than the wavelength of the incident light.

The thickness of the layers affects the optical properties of the pigment. If n is the refractive index of a layer and d is its thickness, the interference color in which a thin layer appears is given by the product n·d (the product is also known as the optical thickness). If standard light is reflected by a layer of this type, light having a wavelength λ=4/2N−1·n·d is amplified therein and light having a wavelength λ=2N·n·d is attenuated (N is a natural number). The color variation which occurs with increasing film thickness arises from the amplification or attenuation of certain wavelengths of the incident light by interference. For example, a layer of titanium dioxide having a refractive index of 1.94 with a thickness of 115 nm has an optical thickness of 115 nm·1.94=223 nm. Light having a wavelength of 2·223 nm=446 nm, i.e. blue light, is attenuated on reflection to such an extent that it appears yellow. The more layers of the same optical thickness that the pigment has, the more intense and saturated is the color of the reflected light. In addition, adjustment of the layer thicknesses enables a particularly large variation in the color to be achieved as a function of the viewing angle, i.e. a strong color flop forms. Such adjustment is a matter of routine experimentation as well known in the art.

In a preferred embodiment, the angle-dependent luster pigment particles are modified on the surface, in particular by coating with an organic polymer. This enables their triboelectric properties to be set in accordance with the requirements. The coating may, if desired, be the same or a similar material as the polymeric binder in the toner. This enables particularly good mixing of all the toner constituents and good fixing to the image-receiving material (in general paper) to be achieved.

Surprisingly, it has been found that the triboelectric properties of the angle-dependent luster pigments can be brought into such agreement with those of the conventional toner pigments that the mixture gives a usable dry toner. It is furthermore surprising that the color flop caused by the angle-dependent luster pigments is reduced only a little or not at all by the admixing of the conventional toner pigments. The optimum size of the luster pigment particles can easily be determined by simple preliminary experiments. The particles should on the one hand not be too small in order that the optical impression does not appear washed-out. Very small platelet-shaped particles are no longer essentially parallel to the surface of the support material, but instead are at angles arising more or less by chance. This results in a higher proportion of scattered light. On the other hand, the platelet-shaped particles must also not be too large, since otherwise the miscibility with the other toner pigments may be impaired.

In addition to binders and charge directors, the toner according to the invention may also comprise charge adjuvants. Suitable charge directors and also binders having an appropriate glass transition temperature are known to the person skilled in the art. Preferred binders are styrene-alkyl (meth)acrylate copolymers, polyester resins and epoxy resins. The proportion of the binders is generally from 1 to 80% by weight, preferably from 2 to 50% by weight, particularly preferably from 3 to 30% by weight, in each case based on the total weight of the toner according to the invention.

The dry toner according to the invention is used, in particular, in security printing, for example in the production of cheques or bills of exchange, certificates or other counterfeiting-proof paper documents. It has to date not been possible to reproduce the color flop effect using the color copiers known hitherto. The prints produced using the toners according to the invention are therefore immediately recognisable as originals.

The present invention thus also relates to a process for the production of images by electrophotographic methods which is characterised in that the dry toner according to the invention is employed. The term “images” here is taken to mean images of all types, including text and graphic representations.

The products produced by the process according to the invention, in particular security prints, are likewise part of the present invention.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosure[s] of all applications, patents and publications, cited above or below, and of corresponding German application no. 10124657.9, filed May 18, 2001, is hereby incorporated by reference.

### EXAMPLE

A mixture was prepared from 45 g of angle-dependent pearlescent pigment (turquoise/purple color effect) and 5 g of a conventional toner (®Ultra Magnefine dry toner from Panasonic). The mixture was then printed onto standard copy paper using an office laser printer (Brother HL-8-e). No problems or faults occurred during printing. The print image exhibited a pronounced turquoise-purple color flop in front of a black background.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. An electrophotographic dry toner comprising at least one platelet-shaped, angle-dependent luster pigment.

2. A dry toner according to claim 1, wherein the luster pigment is a pearlescent pigment.

3. A dry toner according to claim 1, wherein the proportion of angle-dependent luster pigment is from 10 to 99% by weight, based on the total weight of the toner.

4. A dry toner according to claim 1, wherein the angle-dependent luster pigment is a multicoated, platelet-shaped, opaque or semi-transparent substrate.

5. A dry toner according to claim 4, wherein the platelet-shaped substrate is a material which partially or fully absorbs incident light.

6. A dry toner according to claim 5, wherein the platelet-shaped substrate is mica, glass, graphite, graphite-coated mica, iron oxide flakes, SiO₂ flakes, TiO₂ flakes or aluminium oxide.

7. A dry toner according to claim 4, wherein the platelet-shaped substrate is surrounded by a first layer of a metal oxide of high refractive index or of a metal, a second layer of a metal oxide of low refractive index and a third layer of a metal oxide or of a metal, where the difference between the refractive indices of the said layers is at least 0.1.

8. A dry toner according to claim 7, wherein the layer of high refractive index is nickel, aluminium, TiO₂, ZrO₂, Fe₂O₃, Fe₃O₄, Cr₂O₃ and/or ZnO.

9. A dry toner according to claim 7, wherein the metal oxide of low refractive index is Al₂O₃ and/or a mixture of SiO₂/MgF₂.

10. A dry toner according to claim 6, wherein the thickness of the layers of the metal oxide of high refractive index is 10 to 300 nm, and the thickness of the metal layers is about 5 to 35 nm.

11. A dry toner according to claim 6 wherein the thickness of the layers of the metal oxide of low refractive index is 2 to 800 nm.

12. A dry toner according to claim 1 further comprising dyes and/or colored pigments with no interference effect.

13. A dry toner according to claim 1, comprising carriers, binders, charge directors, or charge adjuvants.

14. A process for the production of images by electrophotographic methods, comprising applying a dry toner according claim 1.

15. A security print comprising the dry toner according claim 1.
